(19) United States
(12) Patent Application Publication
(10) Pub. No.: US 2013/0254446 A1
(43) Pub. Date: Sep. 26, 2013

(54) Memory Management Method and Device for Distributed Computer System

(71) Applicant: Huawei Technologies Co., Ltd., Shenzhen (CN)

(72) Inventors: Gaohuai Han, Hangzhou (CN); Wei Wang, Hangzhou (CN); Xishi Qiu, Hangzhou (CN)

(73) Assignee: Huawei Technologies Co., Ltd., Shenzhen (CN)

(21) Appl. No.: 13/892,203

(22) Filed: May 10, 2013

Related U.S. Application Data
(63) Continuation of application No. PCT/CN2011/077381, filed on Jul. 20, 2011.

(51) Int. Cl. G06F 13/40

(52) U.S. Cl. CPC G06F 13/4081
USPC 710/304

(57) ABSTRACT

A method and a device for managing memories in a node are provided. The method includes: setting an appointed memory module in a slave node as a key memory module, setting, in a primary node, a mirror memory module of the key memory module, where same data is stored in the key memory module and the mirror memory module; and implementing hot swap processing of the slave node or the key memory module by using the mirror memory module. In the embodiments of the present invention, mirroring is formed by the key memory module in the slave node and the mirror memory module in the primary node, and the hot swap processing of the slave node or the key memory module is implemented by using the mirror memory module. Thus hot swapping of a single memory module is supported.

### CROSS-REFERENCE TO RELATED APPLICATION

This application is a continuation of International Application No. PCT/CN2011/077381, filed on Jul. 20, 2011, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of electronic technology, and in particular, to a memory management method and device for a distributed computer system.

### BACKGROUND

Non-Uniform Memory Access (NUMA) is a distributed structure, including a primary node and a slave node. Each node includes a processor, one or more memory modules and a unit controller. In each node, the memory module and a peripheral are mounted on each processor. The NUMA is mainly characterized in that: any processor of any node is capable of accessing any memory module and peripheral; and different delays exist in the accessing of different memories by every processor. Each set of a processor and memory is connected to a same system, so the NUMA presents its advantages in expandability, plus features such as high reliability, high applicability, and high serviceability, and the NUMA has been widely applied in the field of medium and high-end servers.

Each node of the NUMA includes some memories (a kernel memory and a reserved memory) that cannot be migrated. If hot swap processing is directly performed on the memory that cannot be migrated, data stored in the memory that cannot be migrated will be lost, and in a worse case the system will be down, so that dynamic resource adjustment of the node cannot be implemented.

In the prior art, a hot swap processing method for a memory of a node is that: when the memory of a node is required to undergo hot swap processing, overall migration and copying are performed with a node as a unit.

In the implementation of the present invention, the inventor finds that the hot swap processing method for the memory of the node in the prior art at least has the following problems.

This solution requires that a backup node is provided for every node, and configuration of the backup node is exactly the same as that of a primary node, leading to a serious waste of resources. In an actual application scenario, a unit for hot swapping may be one or more memory modules in a node, but hot swap processing on only part of memories in the node cannot be implemented in this solution.

### SUMMARY

Embodiments of the present invention provide a memory management method and device for a distributed computer system, so as to implement effective hot swap processing on a part of a memory module with no backup node being provided and no data being lost, where the part of the memory module cannot be migrated in a node.

A memory management method for a distributed computer system, includes: determining a key memory module in a memory of a slave node in a distributed computer system, and setting, in a primary node, a mirror memory module of the key memory module; where the mirror memory module is used for implementing hot swapping of the key memory module, and same data is stored in the key memory module and the mirror memory module.

A memory management device for a distributed computer system, includes: a memory module setting module configured to set an appointed memory module in a slave node as a key memory module, and set, in a primary node, a mirror memory module of the key memory module, where same data in the key memory module and the mirror memory module; and a hot swap processing module configured to implement hot swap processing of the slave node or the key memory module by using the mirror memory module.

From the technical solution provided by the embodiments of the present invention, it can be seen that, in the embodiments of the present invention, mirroring is formed by the key memory module in the slave node and the mirror memory module in the primary node, and the hot swap processing of the slave node or the key memory module is implemented by using the mirror memory module. Therefore, problems, that during a hot swap process of the node, part of the memories that cannot be migrated cannot go offline and data is lost, are solved, and hot swapping of a single memory module is supported.

### BRIEF DESCRIPTION OF THE DRAWINGS

FIG. 1 is a processing flow chart of a memory management method for a distributed computer system according to Embodiment 1 of the present invention;

FIG. 2 is a processing flow chart of a memory application method according to Embodiment 2 of the present invention; and

FIG. 3 is a specific structural diagram of a memory management device for a distributed computer system according to Embodiment 3 of the present invention.

### DETAILED DESCRIPTION

### Embodiment 1

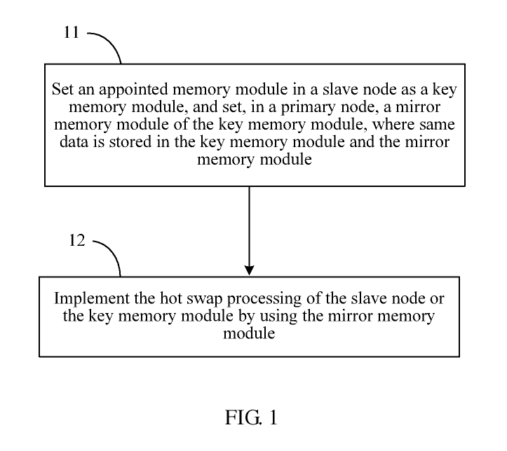

A processing procedure of a memory management method for a distributed computer system provided by this embodiment, as shown in FIG. 1, includes:

11: Set an appointed memory module in a slave node as a key memory module, and set, in a primary node, a mirror memory module of the key memory module, where same data is stored in the key memory module and the mirror memory module.

In the embodiment of the present invention, through a baseboard management controller (BMC), a basic input output system (BIOS) is controlled to set one or more appointed memory modules in the slave node as key memory modules, and all memories that cannot be migrated through a software level operation system (OS) are concentrated stored and in the key memory module. In the slave node, memories that can be migrated through the software level OS are stored and put in an ordinary memory module other than the key memory module.

Further, the number of key memory modules in the slave node may be dynamically adjusted according to system requirements. For example, when the memory that cannot be migrated in the slave node is not sufficient, the number of the key memory modules may be increased through a BIOS command; for another example, when key memory module resources in the slave node are sufficient and idle, the number of key memory modules may be decreased through a BIOS command, so that a mirror memory may be released to improve resource utilization.

When data write, modification and deletion operations are performed in the key memory module of the slave node, the same operations are performed in the mirror memory module of the slave node, so as to ensure that the same data is stored in the key memory module and the mirror memory module. When the hot swap processing is not performed on the slave node or the key memory module, a data read operation is performed through the key memory module of the slave node.

12: Implement the hot swap processing of the slave node or the key memory module by using the mirror memory module.

When all memory modules in the slave node are required to be hot swapped out, the key memory module in the slave node is disabled, the mirror memory module in the primary node is enabled, and operation processing in the key memory module is transferred to the mirror memory module. After migration processing is performed on memories stored and put in the ordinary memory modules other than the key memory module in the slave node, all memory modules in the slave node are powered off and hot swapped out. It can be understood that, in practical application, the process of performing migration processing on the ordinary memory in the slave node may be completed before the process of transferring the operation processing in the key memory module to the mirror memory module.

When only the key memory module in the slave node is required to be hot swapped out, first, a memory mirror switch operation is performed, the key memory module in the slave node is disabled, the mirror memory module in the primary node is enabled, and the operation processing in the key memory module is transferred to the mirror memory module. And then, the key memory module in the slave node is powered off and hot swapped out.

After the key memory module is hot swapped into the slave node, power-on is performed on the key memory module, and the key memory module in the slave node and the mirror memory module in the primary node are enabled. After data synchronization processing between the key memory module and the mirror memory module is performed, a memory mirror switch operation is performed, the mirror memory module in the primary node is disabled, and the key memory module in the slave node continues to be enabled. When the ordinary memory module is also hot swapped into the slave node, normal power-on and enabling operations are performed on the ordinary memory module.

From the technical solution provided by the embodiment of the present invention, it can be seen that, in the embodiment of the present invention, mirroring is formed by the key memory module in the slave node and the mirror memory module in the primary node, and the hot swap processing of the slave node or the key memory module is implemented by using the mirror memory module. Therefore, problems, that during a hot swap process of the node part of the memories that cannot be migrated cannot go offline and data is lost are solved. Furthermore, hot swapping of a single memory module is supported, and a backup node is not required to be provided, thereby implementing resource dynamic adjustment of the node effectively.

### Embodiment 2

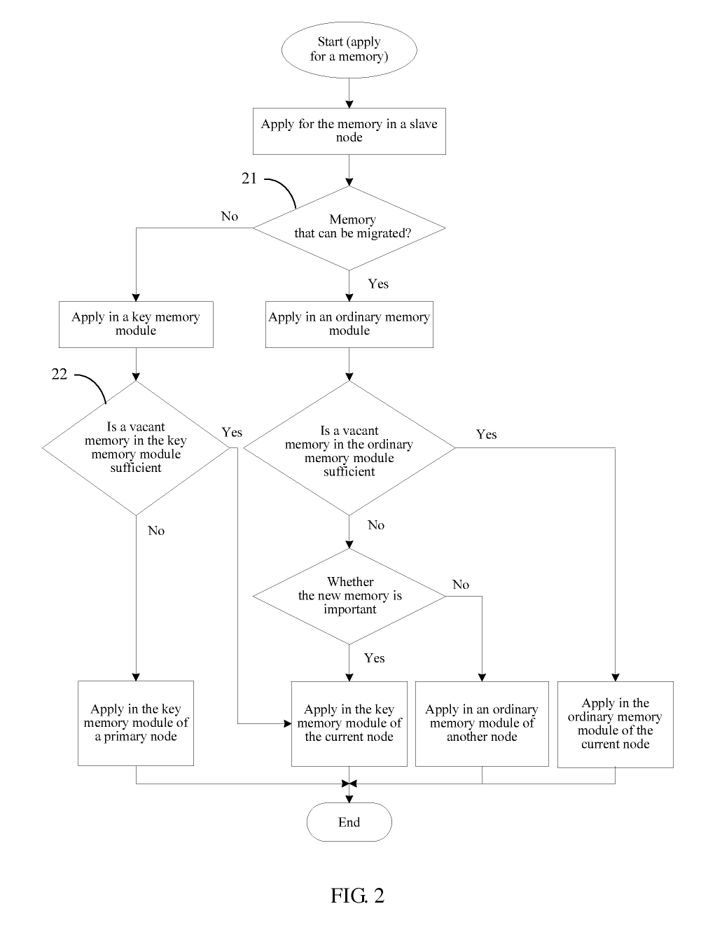

When a slave node applies for a memory, it is required to identify the type of the memory applied for, and perform memory allocation in a corresponding memory area according to the type of the memory applied for. A processing procedure of a memory application method provided by the embodiment is shown in FIG. 2, and specifically the processing process includes:

21: when a slave node applies for a memory, judging whether the memory applied for is a memory that cannot be migrated; if the memory applied for is a memory that cannot be migrated, applying for the memory in a key memory module of the slave node; If the memory applied for is not a memory that cannot be migrated, applying for the memory in an ordinary memory module of the slave node; and

22: when the memory is applied for in the key memory module of the slave node, if a vacant memory in the key memory module is sufficient, allocating the memory applied for in the key memory module of the slave node; otherwise, applying for the memory in a key memory module of a primary node.

When the memory is applied for in the ordinary memory module of the slave node, if a vacant memory of the ordinary memory module is sufficient, the memory applied for is allocated in the ordinary memory module of the slave node; otherwise, it is required to judge whether the memory applied for is important, if the memory applied for is important, the memory is applied for in the key memory module of the slave node, and if the memory applied for is not important, the memory is applied for in an ordinary memory module of another slave node.

From the technical solution provided by the embodiment of the present invention, it can be seen that, in this embodiment, the memory allocation is performed in the corresponding memory area according to the type of the memory applied for.

### Embodiment 3

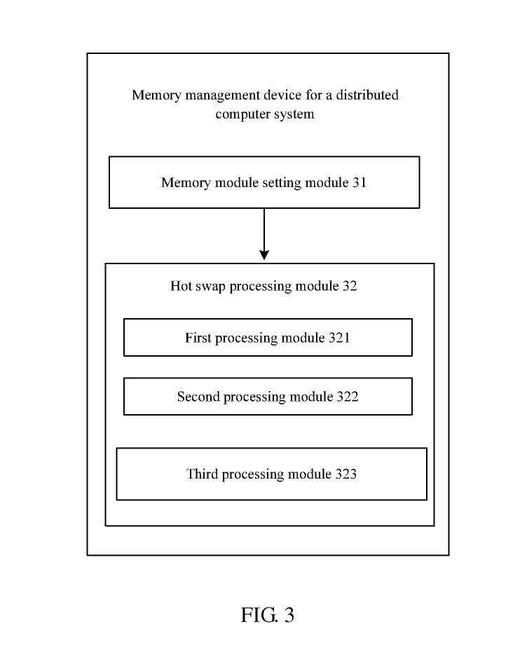

A memory management device for a distributed computer system is provided by this embodiment, its specific structure is as shown in FIG. 3, and the device includes: a memory module setting module 31 configured to set an appointed memory module in a slave node as a key memory module, and set, in a primary node, a mirror memory module of the key memory module, where same data is stored in the key memory module and the mirror memory module; and a hot swap processing module 32 configured to implement hot swap processing of the slave node or the key memory module by using the mirror memory module.

Specifically, the memory module setting module 31 is further configured to, when data write, modification and deletion operations are performed in the key memory module of the slave node, perform the same operations in the mirror memory module of the primary node; and when the hot swap processing is not performed on the slave node or the key memory module, perform a data read operation through the key memory module of the slave node.

Specifically, the hot swap processing module 32 may include: a first processing module 321 configured to, when all memory modules in the slave node are required to be hot swapped out, disable the key memory module in the slave node and enable the mirror memory module in the primary node, and transfer operation processing in the key memory module to the mirror memory module; after migration processing is performed on memories stored and put in an ordinary memory module other than the key memory module in the slave node, power off and hot swap out all the memory modules in the slave node; a second processing module 322 configured to, when the key memory module in the slave node is required to be hot swapped out, disable the key memory module in the slave node, enable the mirror memory module in the primary node, transfer operation processing in the key memory module to the mirror memory module, and power off and hot swap out the key memory module in the slave node; and a third processing module 323 configured to, when the key memory module is hot swapped into the slave node, perform power-on on the key memory module, enable the key memory module in the slave node and the mirror memory module in the primary node; and after a data synchronization operation between the key memory module and the mirror memory module is performed, disable the mirror memory module and continue to enable the key memory module.

The specific process of the hot swap processing performed on the slave node and the key memory module in the slave node by applying the device in the embodiment of the present invention is similar to that in the foregoing method embodiment, which is not repeated herein.

Persons of ordinary skill in the art can understand that, all or part of procedure in the method according to the embodiments may be accomplished by a computer program instructing relevant hardware. The program may be stored in a computer-readable storage medium. When the program is executed, the process of the method according to the embodiments of the present invention is performed. The storage medium may be a magnetic disk, an optical disk, a Read-Only Memory (ROM), or a Random Access Memory (RAM), and so on.

In conclusion, in the embodiments of the present invention, mirroring is formed by the key memory module in the slave node and the mirror memory module in the primary node, and the hot swap processing of the slave node or the key memory module is implemented by using the mirror memory module. Problems, that during the hot swap process of the node part of the memories that cannot be migrated cannot go offline and data is lost, are solved. Furthermore, hot swapping of a single memory module is supported, and a backup node is not required to be provided, thereby effectively implementing resource dynamic adjustment of the node.

In the embodiments of the present invention, the key memory module for storing and putting the memory that cannot be migrated is set in every slave node, and before the slave node or the key memory module undergoes hot swapping, each slave node still uses the key memory module of the slave node itself, so that remote memory access is not increased.

In the embodiments of the present invention, the memory allocation is performed in the corresponding memory area according to the type of the memory applied for. In the embodiments of the present invention, the mirror memory module is set for the key memory module, so as to recover the key memory module through the mirror memory module when the key memory module is faulty.

The above descriptions are merely exemplary embodiments of the present invention, but do not limit the protection scope of the present invention. Any modification or replacement easily made by persons skilled in the art within the technical scope disclosed by the present invention should fall within the protection scope of the present invention. Therefore, the protection scope of the present invention is subject to the protection scope of the claims.

What is claimed is:

1. A memory management method for a distributed computer system, comprising:
determining a key memory module in a memory of a slave node in a distributed computer system; and
setting, in a primary node, a mirror memory module of the key memory module,
wherein the mirror memory module is configured to implement hot swapping of the key memory module, and
wherein same data is stored in the key memory module and the mirror memory module.

2. The memory management method for the distributed computer system according to claim 1, wherein a memory that cannot be migrated is stored and put in the key memory module.

3. The memory management method for the distributed computer system according to claim 1, wherein the same data is stored in the key memory module and the mirror memory module comprises:
performing the same operations in the mirror memory module of the primary node when data write, modification, and deletion operations are performed in the key memory module of the slave node; and
performing a data read operation through the key memory module of the slave node when hot swap processing is not performed on the slave node or the key memory module.

4. The memory management method for the distributed computer system according to claim 1, wherein the mirror memory module is configured to implement the hot swapping of the key memory module comprises:
disabling the key memory module in the slave node, enabling the mirror memory module in the primary node, and transferring operation processing to be performed in the key memory module to the mirror memory module when all memory modules in the slave node are required to be hot swapped out; and
powering off all the memory modules in the slave node and hot swapping all the memory modules out of the slave node after migration processing is performed on memories stored and put in an ordinary memory module other than the key memory module in the slave mode.

5. The memory management method for the distributed computer system according to claim 1, wherein the mirror memory module is configured to implement the hot swapping of the key memory module comprises:
disabling the key memory module in the slave node, enabling the mirror memory module in the primary node, and transferring the operation processing to be performed in the key memory module to the mirror memory module when the key memory module in the slave node is required to be hot swapped out; and
powering off the key memory module in the slave node and hot swapping the key memory module out of the slave node.

6. The memory management method for the distributed computer system according to claim 1, wherein the mirror memory module is configured to implement the hot swapping of the key memory module comprises:
performing power-on on the key memory module, enabling the key memory module in the slave node, and enabling the mirror memory module in the primary node after the key memory module is hot swapped into the slave node; and
disabling the mirror memory module after a data synchronization operation between the key memory module and the mirror memory module is performed.

7. A memory management device for a distributed computer system, comprising:
a memory module setting module configured to set an appointed memory module in a slave node as a key memory module, and set, in a primary node, a mirror memory module of the key memory module, wherein same data is stored in the key memory module and the mirror memory module; and
a hot swap processing module configured to implement hot swap processing of the key memory module by using the mirror memory module.

8. The memory management device for the distributed computer system according to claim 7, wherein the memory module setting module is further configured to:
perform the same operations in the mirror memory module of the primary node when data write, modification, and deletion operations are performed in the key memory module of the slave node; and
perform a data read operation through the key memory module of the slave node when the hot swap processing is not performed on the slave node or the key memory module.

9. The memory management device for the distributed computer system according to claim 7, wherein the hot swap processing module comprises:
a first processing module configured to, when all memory modules in the slave node are required to be hot swapped out, disable the key memory module in the slave node, enable the mirror memory module in the primary node, and transfer operation processing to be performed in the key memory module to the mirror memory module, and
wherein the hot swap processing module is configured to, after migration processing is performed on memories stored and put in an ordinary memory module other than the key memory module in the slave node, power off all the memory modules in the slave node and hot swap all the memory modules out of the slave node.

10. The memory management device for the distributed computer system according to claim 7, wherein the hot swap processing module comprises a second processing module configured to, when the key memory module in the slave node is required to be hot swapped out, disable the key memory module in the slave node, enable the mirror memory module in the primary node, transfer operation processing to be performed in the key memory module to the mirror memory module, power off the key memory module in the slave node, and hot swap the key memory module out of the slave node.

11. The memory management device for the distributed computer system according to claim 7, wherein the hot swap processing module comprises a third processing module configured to:
perform power-on on the key memory module, enable the key memory module in the slave node, and enable the mirror memory module in the primary node after the key memory module is hot swapped into the slave node; and
disable the mirror memory module after a data synchronization operation between the key memory module and the mirror memory module is performed.

12. A distributed computer system, comprising
a slave node;
a primary node; and
a memory management node,
wherein the memory management node comprises at least one memory and a processor connected to the at least one memory,
wherein the processor is configured to determine a key memory module in a memory of the slave node in the distributed computer system and set, in the primary node, a mirror memory module of the key memory module,
wherein the mirror memory module is configured to implement hot swapping of the key memory module, and
wherein same data is stored in the key memory module and the mirror memory module.

13. The system according to claim 12, wherein the processor connected to the at least one memory is specifically configured to:
perform the same operations in the mirror memory module of the primary node when data write, modification, and deletion operations are performed in the key memory module of the slave node; and
perform a data read operation through the key memory module of the slave node when hot swap processing is not performed on the slave node or the key memory module.

14. The system according to claim 12, wherein the processor connected to the at least one memory is specifically configured to:
disable the key memory module in the slave node, enable the mirror memory module in the primary node, and transfer operation processing to be performed in the key memory module to the mirror memory module when all memory modules in the slave node are required to be hot swapped out; and
power off all the memory modules in the slave node and hot swap all the memory modules out of the slave node after migration processing is performed on memories stored and put in an ordinary memory module other than the key memory module in the slave node.

15. The system according to claim 12, wherein the processor connected to the at least one memory is specifically configured to:
disable the key memory module in the slave node, enable the mirror memory module in the primary node, and transfer the operation processing to be performed in the key memory module to the mirror memory module when the key memory module in the slave node is required to be hot swapped out; and
power off the key memory module in the slave node and hot swap the key memory module out of the slave node.

16. The system according to claim 12, wherein the processor connected to the at least one memory is specifically configured to:
perform power-on on the key memory module, enable the key memory module in the slave node, and enable the mirror memory module in the primary node after the key memory module is hot swapped into the slave node; and
disable the mirror memory module after a data synchronization operation between the key memory module and the mirror memory module is performed.

17. A non-transitory computer readable medium having computer executable instructions for performing a method, comprising:
determining a key memory module in a memory of a slave node in a distributed computer system; and
setting, in a primary node, a mirror memory module of the key memory module,
wherein the mirror memory module is configured to implement hot swapping of the key memory module, and
wherein same data is stored in the key memory module and the mirror memory module.
